(19) United States
(12) Patent Application Publication
(10) Pub. No.: US 2016/0103332 A1
(43) Pub. Date: Apr. 14, 2016

(54) ADJUSTABLE RIMLESS GLASSES FOR EASY REMOVAL

(71) Applicant: Juei Tse Lin, Taipei (TW)

(72) Inventor: Juei Tse Lin, Taipei (TW)

(21) Appl. No.: 14/509,059

(22) Filed: Oct. 8, 2014

(51) Int. Cl. G02C 1/02; G02C 5/12; G02C 5/22; G02C 5/14

(52) U.S. Cl. CPC G02C 1/02; G02C 5/146; G02C 5/122; G02C 5/2281; G02C 2200/06; G02C 2200/08

(57) ABSTRACT

An adjustable rimless glasses for easy removal, comprising rimless lens, temples and nose pads, said rimless lens has outwardly extending protruding portions on both sides; in the front ends of two temples, there are insert holes, rimless lens protruding portions are embedded in the insert hole; in the front ends of two temples are pivoted in the rotator. The rotators can connect with or separate from the exposed part of the rimless lens protruding portions by rotation, so that the rimless lens protruding portions can be located or pulled out of the insert holes. Said nose pads comprise pad, pad arms, fixed axle and base. By the operation of the rotator, temples and rimless lens can be fixed or separated to complete the fast disassembly process of the temples. During the temple assembly process, it does not need the help of screwdriver.

### BACKGROUND OF INVENTION

1. Field of the Invention

The present invention relates generally to glasses and more particularly to a pair of adjustable rimless glasses for easy removal.

2. Description of Related Art

Glasses play a very important role in people's lives as a tool of eyesight protection and myopia prevention. Rimless glasses generally comprise rimless lens and two temples. Moreover, two temples are mostly hinged and fixed with rimless lens by screws and rimless lens. It needs special screwdriver and other tools in disassembly, which makes users unable to replace the temples quickly for the sake of style changes.

Additionally, nose pads form the support structure of glasses on the nose. Nose pads can be roughly divided into two categories including frame-integrated fixe type and frame bolt assembly type. The widespread drawbacks include: 1. the positions of nose pads remain fixed and the pads cannot adjust the distance between the pads and the frame. The same glasses may cause lack of support or inappropriate position of nose support for different users. The user may have to heat the nose pads and adjust the positions of nose pads in a professional glasses service provider. The user cannot adjust independently and thus it is very inconvenient. Additionally, as nose pads and frame are made of the same kind of materials, the glasses look stiff and are uncomfortable to wear.

### SUMMARY OF THE INVENTION

The main objective of the present invention is to overcome the above drawbacks of the prior art and propose an adjustable rimless glasses for easy removal with nose pads of adjustable angle and self-removable temples.

The present invention adopts the following technical solutions:

an adjustable rimless glasses for easy removal, comprising rimless lens, temples and nose pads, wherein: on the two outer edges of said rimless lens, there are outwardly extending protruding portions; the front ends of the two temples are provided with hollow jacks, rimless lens protruding portions are inserted in the jacks and partially exposed in the outside of the rear end of the jack; the front ends of the two temples are pivoted with a rotator, said rotator can realize the insertion or exit from the jacks of the rimless lens protruding portions by connecting with or separating from the part of the part of the rimless lens protruding portions exposed outside of the jack rear end.

Said nose pads comprise pads, pad arms, fixed axle and base; at the bottom of said pad, there is an inwardly extending fixed groove; on both sides of said pad arm, there is the card edge to be inserted into the fixed groove for the fixed connection with the pad. In the other end of said pad arm, there is the cladding part for the two ends of the fixed axle to go through. Said cladding part can rotate against the fixed axle; at both ends of said base, there are lugs. On the top of the side opposite to the two lugs, there are slots extending to the lower part. On the side walls of said slots, there are some through holes; some bumps corresponding to the through holes are set at both ends of said fixed axle. The two ends of said fixed axle can be inserted into the slots, so that bumps can be embedded in the corresponding through holes to realize the fixation of the fixed axle. Said rimless lens is provided with a mounting base to fix the nose pads.

Preferably, said rotator has a bayonet lock and said rimless lens protruding portion has an insert hole. When said protruding portion is inserted in the jack, said insert hole is exposed outside the rear end of said insert hole; said rotator rotates and pushes or pulls the bayonet lock of the insert hole of said protruding portion.

Preferably, the internal side of said two temples corresponding to the rear end of said insert hole, there is a holding groove, the rear end of said insert hole and said holding groove are connected. Said rotator is pivoted inside the holding groove of said temple.

Preferably, one end of said rotator is pivoted inside the holding groove of said temple and the other end of said rotator is inserted inside the accommodating part to divide the other end of said rotator into two branches. Said rotator and the part of said protruding portion that is exposed outside the rear end of the insert hole are fixed and connected, one branch is contained inside said holding groove and the other branch is outside said holding groove to form the rotation operating handle.

Preferably, said two temples comprise temple body and connecting piece, connecting piece is connected with the front end of the temple body; said insert hole and holding groove are in said connecting pieces respectively.

Preferably, said temple body's front end is pivoted in the rear end of said connecting piece and the retaining wall is installed outside the rear end of said connecting piece to limit the continuous rotation of said temple body in the unfolded state.

Preferably, there is a groove with a backward opening in the rear end of said connecting piece, and an extension part in the front end of said temple body. Said extension part is pivoted inside the groove and the structure of said groove bottom forms said rotation-retaining wall.

Preferably, said cladding part is a hollow cylinder; said fixed axle has a polygonal cross-section.

Preferably, a bayonet is set on the side wall of said cladding part; there is a corresponding limit lug on the outer wall of said fixed axle. The lugs inside the bayonet limit the rotating angle of the cladding part.

Preferably, a number of grooves are set in the longitudinal direction along the fixed axle on the internal wall of said cladding part and there are a few grooves surrounding said fixed axle.

According to the above descriptions of the present invention, by comparison with the prior technology, the present invention has the following beneficial effects:

in the present invention, the two edges of said rimless lens have outwardly extending protruding portions. At the front ends of the two temples, there are through insert holes while rotators are pivoted on the temples. The rotators can connect with or separate from the exposed part of the rimless lens protruding portions by rotation, so that the rimless lens protruding portions can be located or pulled out of the insert holes. Hence, by the operation of the rotators, temples and rimless lens can be fixed or separated to complete the fast assembly and disassembly process. During the temple removal process, it does not need the screwdriver. Thus, the present invention is characterized by convenient operation, reliable connection and so on.

Additionally, regarding the present invention's nose pads, the removable assembly and process of pad, pad arms, fixed axle and base can be realized. Pads can be selected according to the demand on colors or materials by different groups of consumers and different races, so that the wearing of glasses will be more comfortable and stylish and easy for replacement and removal to meet the demands of different consumer groups.

### BRIEF DESCRIPTION OF THE DRAWINGS

FIG. 1. The present invention's structural schematic diagram.

FIG. 2. The present invention rimless lens and temples' exploded schematic diagram.

FIG. 3. The present invention connecting piece's enlarged schematic diagram.

FIG. 4. The present invention rotator's enlarged schematic diagram.

FIG. 5. The present invention temples and rimless lens' installation schematic diagram.

FIG. 6. The present invention nose pads and mounting base's structural schematic diagram.

FIG. 7. The present invention nose pads' overall schematic diagram.

FIG. 8. The present invention nose pads' composition schematic diagram.

FIG. 9. The present invention pad arms and fixed axle coordination schematic diagram.

FIG. 10. Fixed axle schematic diagram.

FIG. 11. base schematic diagram.

### DETAILED DESCRIPTION OF THE INVENTION

The present invention is further described by the specific embodiments of the present invention.

### Embodiment 1

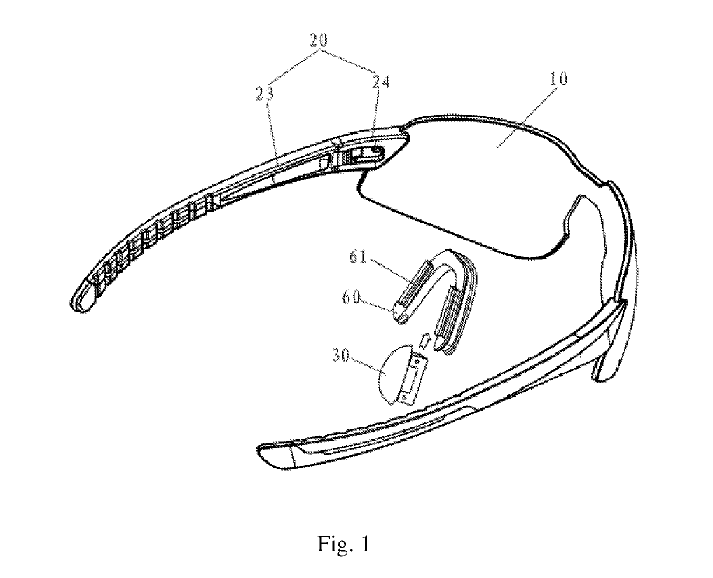

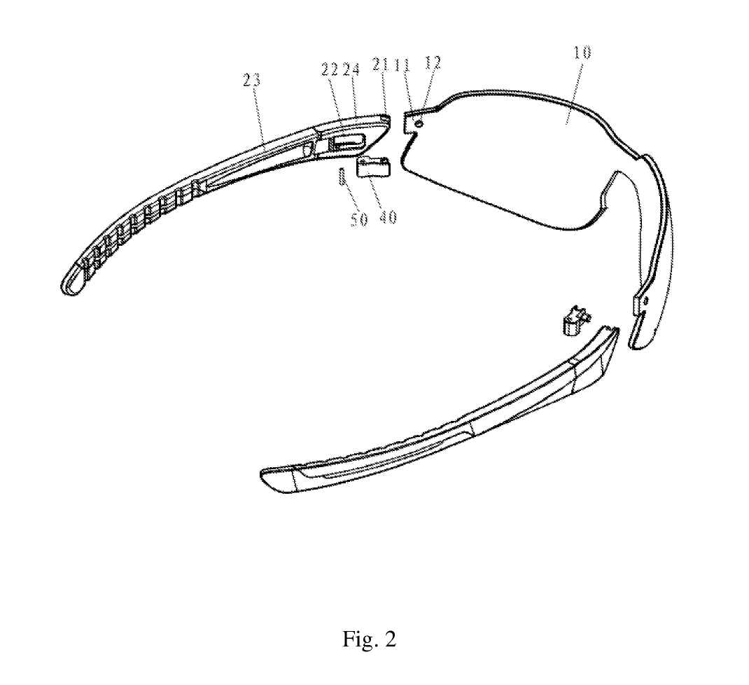

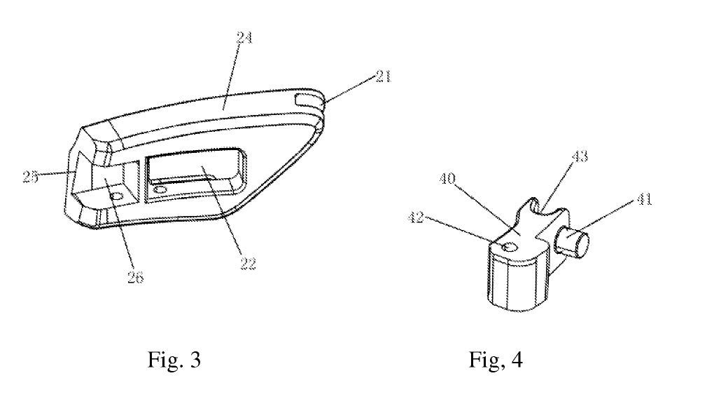

As shown in FIG. 1, an adjustable rimless glasses for easy removal, comprise rimless lens 10, temples 20 and nose pads 30. As shown in FIGS. 2 to 4, the two outer edges of said rimless lens 10 have the outwardly extending protruding portions 11. There are the through insert holes 21 in the front ends of the two temples 20. The rimless lens 10 protruding portions 11 are inserted into the insert holes 21 and are partially exposed outside the rear ends of insert holes 21. Rotators 40 are pivoted in the front ends of two temples 20. Said rotator 40 can connect with or separate from the exposed part of the rimless lens 10 protruding portions 11 by rotation, so that the rimless lens 10 protruding portions 11 can be located or pulled out of the insert holes 21. Specifically, rotator 40 has a bayonet lock 41, rimless lens 10 protruding portions 11 has an insert hole 12. When protruding portions 11 is inserted into the insert hole 21, said insert hole 12 is exposed outside the rear end of insert hole 21. The rotator 40 rotates and pushes or pull the bayonet lock 41 of the insert hole 12 of protruding portions 11. A holding groove 22 is set in the corresponding rear side location of the insert hole 21 in the front end of temple 20. The rear end of insert hole 21 and said holding groove 22 are connected. When the rimless lens 10 protruding portions 11 are inserted in the insert hole 21, insert hole 12 is inside holding groove 22; rotator 40 is pivoted inside the holding groove 22 of temple 20.

Furthermore, one end of rotator 40 is pivoted inside the holding groove 22 of temple 20, specifically, rotator 40 is a block structure, at one end, there is a through hole 42, said through hole 42 is outfit on a hinge pin 50, and said hinge pin 50 is inserted between the upper groove wall and lower groove wall of holding groove 22 and rotator 40 can rotate on said hinge pin 50. The other end of rotator 40 is installed inside the accommodating part 43, the other end of rotator 40 is divided into two branches. When the rotator 40 bayonet lock 41 is embedded inside the insert hole 12 of rimless lens 10, one branch of rotator 40 is contained inside holding groove 22 and the other branch is outside the holding groove 22 to form the rotator 40 rotation operating handle.

Furthermore, two temples 20 comprise temple body 23 and connecting piece 24. The connecting piece 24 is connected with the front end of the temple body 23. The insert hole 21 and holding groove 22 are installed in said connecting pieces 24. As a preferred selection, the front end of temple body 23 is pivoted in the rear end of the connecting piece 24. Outside the rear end of the connecting piece 24, there is a rotation-retaining wall 25 to limit the longitudinal movement of temple body 23 in the unfolded state. Specifically, inside the rear end of the connecting piece 24, there is a backward opening groove 26. In the front end of temple body 23, there is an extension part 27, said extension part 27 enters said groove 26 through the back opening of said groove 26 and is embedded inside it (said extension part 27 is embedded in the groove 26 in the same manner with the above rotator 40 embedded inside holding groove 22), the end surface of the bottom of said groove 26 forms the rotation-retaining wall 25.

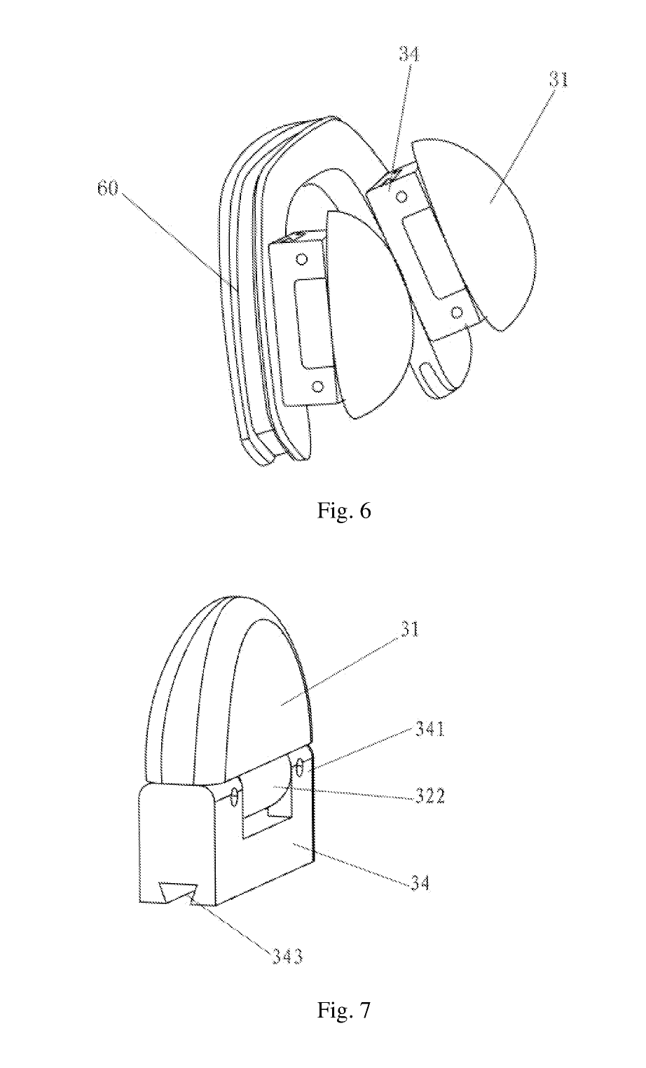

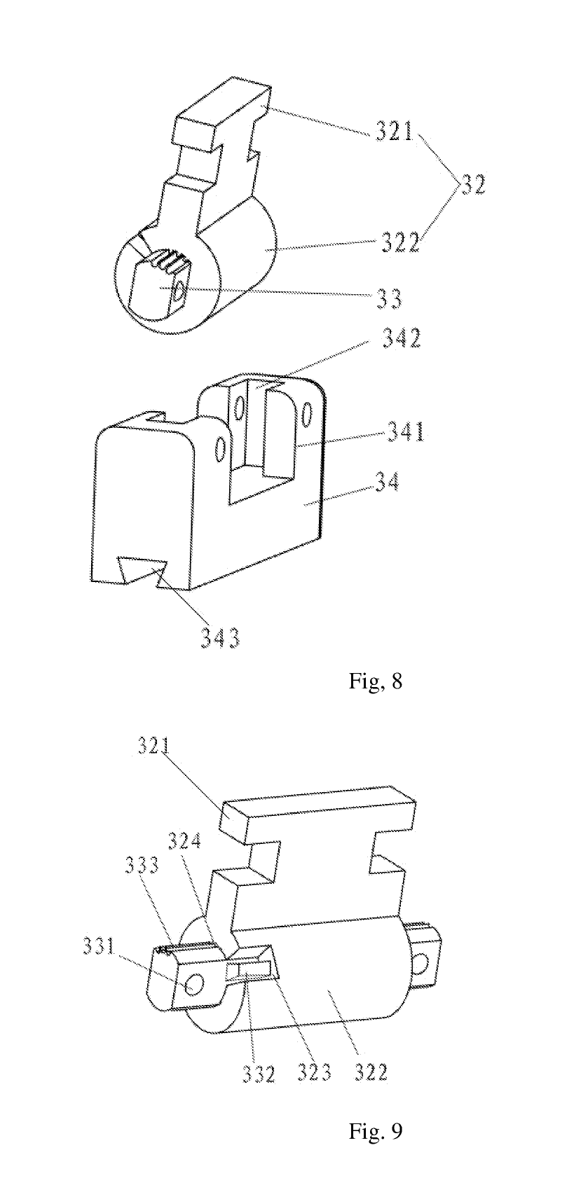

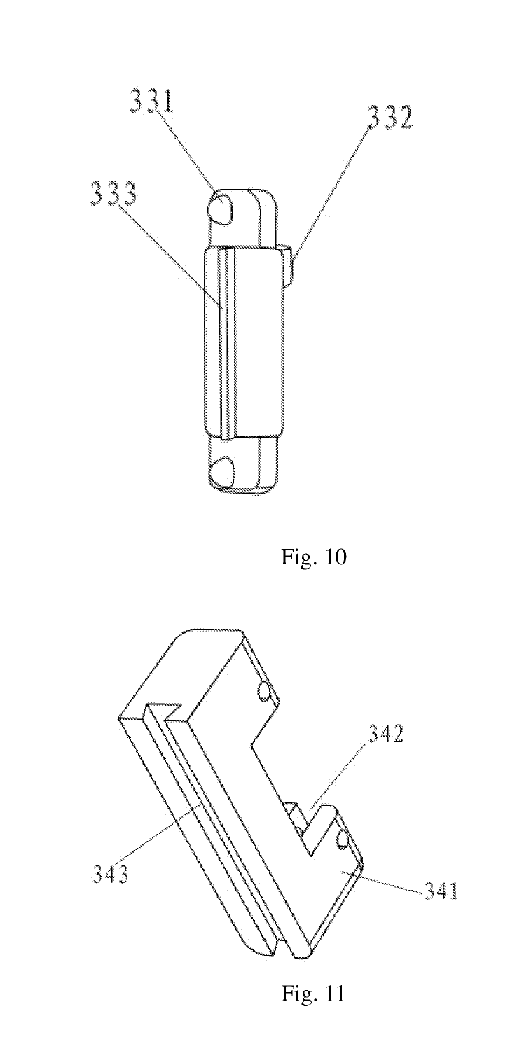

As shown in FIGS. 6 to 11, said nose pad 30 comprise pad 31, pad arms 32, fixed axle 33 and base 34. Said pad 31 has the inwardly extending fixed groove 311. said pad arms 32 has the edge 321 inserted into fixed groove 311 and connected with pad 31 on both sides. Said pad arms 32 have the cladding part 322 for the fixed axle 33 to go through on both sides. Said cladding part 322 can rotate against the fixed axle 33. Said base 34 has a lug 341 on both ends. The two lugs 341 have the slots 342 extending to the bottom at the top. There are a few through holes on the wall of said slot 342. Said fixed axle 33 has some bumps 331 corresponding to through holes on both ends. The two ends of said fixed axle 33 can be inserted into slots 342, so that bumps 331 can be embedded in the corresponding through holes to realize the fixation of fixed axle 33, said rimless lens 10 has a mounting base 60 to fixe nose pads 30. Said mounting base 60 is U-shaped and it has two fixed strips 61 for the fastening of the two nose pads 30. Said fixed strip 61 has a trapezoid cross section. At the bottom of base 34 of nose pad 30, there is the installation groove 343 to fit the fixed strip 61.

The cladding part 322 is a hollow cylinder, and the cross-section of the fixed axle 33 is polygonal. To facilitate the rotation of cladding part 322, a notch on the outer wall of the cladding part 322 can be installed in the longitudinal direction of fixed axle 33 (not illustrated).

Additionally, to limit the rotation angle of the cladding part 322, there is a bayonet 323 on the lateral side of the cladding part 322, and there is a corresponding limit lug 332 on the outer wall of the fixed axle 33. Said the limit lug 332 is located inside bayonet 323.

The present invention's cladding part 322 has a few grooves 324 in the longitudinal direction of fixed axle 33 and there is a protruding strip 333 outside fixed axle 33 to increase friction when the cladding part 322 rotates and create a sense of gears.

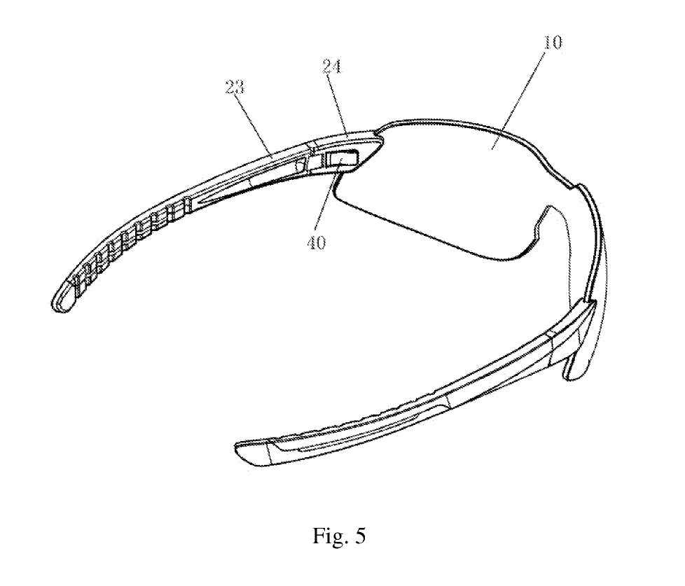

The front end of the present invention temple 20 refers to the end of temple 20 bordering on rimless lens 10. Correspondingly, the other end of temple 20 is the rear end of temple 20. Similarly, the front and rear ends of the foregoing connecting piece 24 are defined as the front and rear ends of temple body 23. In installation, as shown in FIGS. 1, 2, and 5, rimless lens 10 protruding portion 11 is embedded into the connecting piece 24 insert hole 21, and the protruding portion 11 of insert hole 12 is exposed outside the insert hole 21 and is located inside the holding groove 22; then, along the lateral direction of temple 20, it rotates the rotator 40 into the holding groove 22 of connecting piece 24 and pushes the bayonet lock 41 of rotator 40 into rimless lens 10 insert hole 12 to complete the assembly of rimless lens 10 and two temple 20. In disassembly, the branch of the holding groove 22 of the connecting piece 24 is exposed by pulling the rotator 40 to rotate the rotator 40 along the internal side of temple 20 to get out of the holding groove 22 of connecting piece 24 while getting rotator 40 bayonet lock 41 out of the insert hole 12 of rimless lens 10. In this case, rimless lens 10 and temple 20 are separated, it needs only to pull rimless lens 10 protruding portion 11 out of the insert hole 21 of connecting piece 24 to complete the fast removal process of rimless lens 10 and temple 20.

Nose pad 30 installation process: fixed axle 33 is input into cladding part 322 of pad arm 32, and the edge 321 of the end of pad arm 32 is inserted into fixed groove 311 to fix pad 31; the cladding part 322 of fixed axle 33 matches with the slot 342 of base 34, so that the bumps 331 of the two ends of fixed axle 33 are embedded inside the through holes to realize the fixation of the fixed axle 33 to complete the assembly of the nose pad 30. Two installation grooves 343 at the bottom of base 34 of nose pad 30 are slipped into the fixed strips of the mounting base 60 to realize the fixation. In this way, the nose pad 30 can be fixed on the mounting base 60. In disassembly, the base 34 of the nose pad 30 can be removed from the fixed strip 61 before removing pad 31, pad arm 32 and fixed axle 33.

### Embodiment 2

The main technological features of Embodiment of the adjustable rimless glasses for easy removal are the same with those of Embodiment 1. The differences are: there are two mounting bases on the noses of the rimless glasses, and each mounting base has a fixed strip to fix the nose pad.

The foregoing embodiments are the special implementations of the present invention. However, the design concepts of the present invention are not limited to the above. Any non-substantial changes of the present invention are the infringements on the protected rights of the present invention.

1. An adjustable rimless glasses for easy removal, comprising rimless lens, temples and nose pads, wherein:
said rimless lens have outwardly extending protruding portions on both sides; in the front ends of two temples, there are through insert holes, rimless lens protruding portions are inserted into insert holes and partially exposed outside the insert holes; the front ends of the two temples are pivoted on the rotators; said rotator can connect with or separate from the exposed part of the rimless lens protruding portions by rotation, so that the rimless lens protruding portions can be located or pulled out of the insert holes;
said nose pads comprise pad, pad arms, fixed axle and base; there is an inwardly extending fixed groove at the bottom of said pad; on both sides of the end of said pad arms, there is an edge to connect the fixed groove with pad on one end; on the other end, said pad arm has a cladding part for the fixed axle, said cladding part can rotate against the fixed axle;
said base has a lug on both ends and there are slots extending to the bottom; there are a few through holes on the wall of said slot; said fixed axle has a few bumps corresponding to the through holes at both ends;
said fixed axle can be inserted inside the slots so that the bumps can be embedded inside the through holes to fix the fixed axle; said rimless lens has the mounting base to fix the nose pads.

2. The adjustable rimless glasses for easy removal as claimed in claim 1, wherein said rotator has a bayonet lock, said rimless lens protruding portion has an insert hole; when said protruding portion is embedded into the insert hole and said insert hole is exposed outside said insert hole, said rotator can push or pull the bayonet lock of said protruding portion insert hole by rotation.

3. The adjustable rimless glasses for easy removal as claimed in claim 1, wherein there are holding grooves on the locations corresponding to said insert holes on the walls of the front end of said two temples; the rear end of said insert hole and said holding groove are connected; said rotator is pivoted inside the holding groove of said temple.

4. The adjustable rimless glasses for easy removal as claimed in claim 3, wherein one end of said rotator is pivoted inside the holding groove of said temple and the other end of said rotator has the accommodating part, so that the other end of said rotator is divided into two branches; when said rotator and the part of said protruding portion exposed to the rear end of the insert hole are fixed, a branch is contained inside said holding groove and the other end is outside said holding groove to form the rotation operating handle.

5. The adjustable rimless glasses for easy removal as claimed in claim 3, wherein said two temples comprise temple body and connecting piece;
the connecting piece is connected with the front end of the temple body;
said insert hole and holding groove are installed inside said connecting pieces.

6. The adjustable rimless glasses for easy removal as claimed in claim 5, wherein the front end of said temple body is pivoted in the rear end of said connecting piece and there is a rotation-retaining wall outside said connecting piece to limit the movement of said temple body in the unfolded state.

7. The adjustable rimless glasses for easy removal as claimed in claim 6, wherein said connecting piece rear end has a groove with a backward opening; the front end of said temple body has an extension part, said extension part is pivoted in the groove and the structure of the groove bottom forms said rotation-retaining wall.

8. The adjustable rimless glasses for easy removal as claimed in claim 1, wherein said cladding part is a hollow cylinder, said fixed axle cross section is polygonal.

9. The adjustable rimless glasses for easy removal as claimed in claim 1, wherein said cladding part has a bayonet on the lateral wall and there is a limit lug on the outer wall of said fixed axle; said limit lug is located inside the bayonet to limit the rotation angle of the cladding part.

10. The adjustable rimless glasses for easy removal as claimed in claim 1, wherein said cladding part has a number of grooves in the longitudinal direction of the fixed axle on the internal walls; there are a few protruding strips around said fixed axle.
